(19) United States
(12) Patent Application Publication
(10) Pub. No.: US 2015/0213240 A1
(43) Pub. Date: Jul. 30, 2015

(54) System and Method for Tracking Copyrighted Audio Material Broadcast in a Commercial Establishment

(71) Applicants: Eron Bucciarelli-Tieger, Englewood, OH (US); Todd Tieger, Princeton, NJ (US)

(72) Inventors: Eron Bucciarelli-Tieger, Englewood, OH (US); Todd Tieger, Princeton, NJ (US)

(21) Appl. No.: 14/169,134

(22) Filed: Jan. 30, 2014

(51) Int. Cl. G06F 21/16; H04H 60/66; G06Q 30/04; H04H 20/61; H04R 3/12; H04H 60/58; H04H 20/93

(52) U.S. Cl. CPC G06F 21/16; H04H 60/58; H04H 60/66; H04H 20/93; H04H 20/61; H04R 3/12; G06Q 30/04; H04H 2201/13; H04R 2227/005

(57) ABSTRACT

A system and method of determining if copyrighted audio material is being performed or broadcast within an establishment. One or more audio monitoring units are placed within the establishment. The audio monitoring unit detects audio signals inside the establishment and converts those signals into a corresponding data. Server software is provided that receives the data via a communications network. The server software compares the data to at least one database of copyrighted material looking for segment matches. The server software analyzes the segment matches to determine if the duration and/or nature of any segment match warrants the payment of a royalty. One or more performing rights organizations are sent a report detailing performances within an establishment so proper royalties can be distributed to the appropriate songwriters.

### BACKGROUND OF THE INVENTION

1. Field of the Invention

In general, the present invention relates to systems and methods that are used to identify copyrighted audio, such as music, movie soundtracks and the like, being performed or broadcast in a particular area. More particularly, the present invention relates to systems and methods that identify copyrighted audio material for the purpose of calculating royalties.

2. Prior Art Description

Many restaurants, bars, supermarkets, retail stores and other commercial establishments play music or other audio material for the pleasure of their patrons. Often that audio material is obtained from a private audio source service, such as Muzak®. If so, the audio source service tracks what audio material is being played and pays the appropriate royalty fees to the copyright owners of the audio material. Similarly, if music in a bar is played from a jukebox, then that music is tracked and the appropriate royalties paid. The problem occurs when copyrighted audio material is performed or broadcast in a commercial establishment from a source that is not tracked.

Radio stations are required to track the copyrighted material they broadcast to the public. In the prior art, systems have been developed that automatically monitor and track such transmissions. Such prior art systems are exemplified by U.S. Patent Application Publication No. 2011/0015968 to Carlson, entitled Automated Media And Content Reporting System For Broadcast Media. Although such system are capable of monitoring commercial broadcast sources, such as radio stations and webcast websites, such systems do nothing to track if such broadcasts are being received by a commercial establishment and being rebroadcast or performed for the patrons of that establishment.

In many instances, a restaurant owner or other business owner may simply broadcast music from the radio, a cable television channel or even from a private collection of music. They may also host live bands, or broadcast music from a private play list of an MP3 player or smart phone. Generally speaking, under United States copyright law, the copyright owners of audio material are due a royalty each and every time the audio material is performed or broadcast within a commercial establishment by the owners of that commercial establishment. Often bars and restaurants pay fees that enable them to broadcast music aloud. However, the fee is a blind payment and has no direct relationship to what music is actually being played. This means that copyright owners are being pooled together rather than being paid specific fees for specific broadcasts or performances of the copyrighted work. This blind payment of fees has been tolerated simply because there has been no reliable way available to accurately monitor and track the broadcasts and performances of audio material in most establishments.

A need therefore exists for a system and method of tracking when copyrighted material is performed or broadcast to the patrons of an establishment regardless of the original source of the copyrighted material. In this manner, copyright owners can be paid the proper royalties they are due under the law. This need is met by the present invention as described and claimed below.

### SUMMARY OF THE INVENTION

The present invention is a system and method of determining if copyrighted audible material is being performed or broadcast within a particular establishment. An audio monitoring unit is connected to the public address system within the establishment. The audio monitoring unit has an input port array and an output port array. As audio signals travel through the audio monitoring unit from the input port array to the output port array, the signals are tapped for analysis. The tapped signals are conditioned into systems data of the appropriate format. That systems data is then transmitted to a remote computer processor via a communications network.

Server software, run by a computer processor, is provided that receives the systems data via the communications network. The server software serves two primary functions. In its first function, the server software compares the digital signal to at least one database of copyrighted material looking for segment matches. The server software analyzes the segment matches to determine if the duration and/or nature of any segment match warrants the payment of a royalty. If a royalty is owed, the Performing Rights Organization will be notified of the date and time and location of the performance in order to pay the appropriate royalty to the songwriter.

In its second function, the server software collects information about when and where the copyrighted material is being performed or broadcast. Access to this information can be sold or otherwise utilized by the system's administrator.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a block diagram schematic showing the components of the overall audio tracking system; and

FIG. 2 is a block diagram illustrating an exemplary method of operation for the present invention audio tracking system.

### DETAILED DESCRIPTION OF THE DRAWINGS

Although the present invention audio tracking system and method can be embodied in many ways, only one embodiment is illustrated. This exemplary embodiment is selected in order to set forth one of the best modes contemplated for the invention. The illustrated embodiment, however, is merely exemplary and should not be considered a limitation when interpreting the scope of the appended claims.

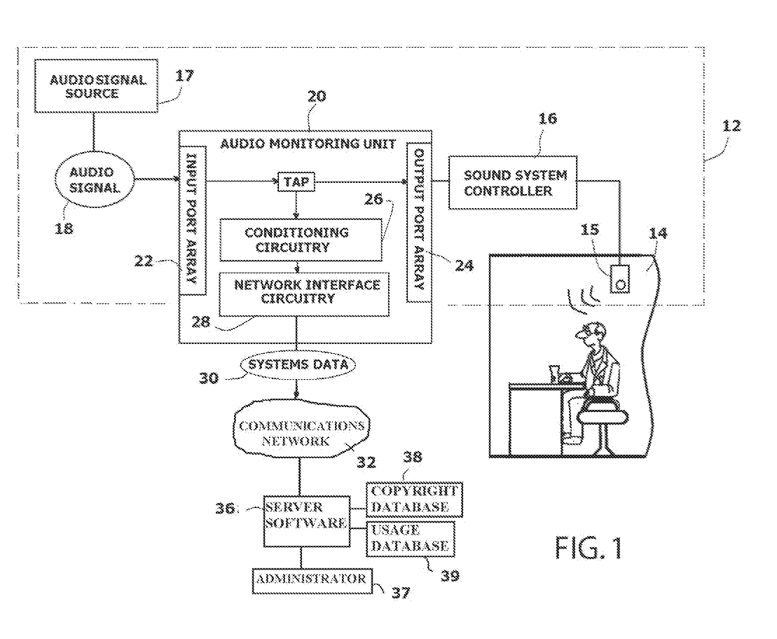

Referring to FIG. 1, a schematic of the overall audio tracking system 10 is illustrated. A commercial establishment 14, such as a restaurant, a bar, a retail store, an office, or the like typically has a public address system 12 through which music and/or messages are broadcast to the patrons of that commercial establishment 14. The public address system 12 typically has a series of speakers 15 that are mounted throughout the commercial establishment 14. The public address system 12 also typically has an electronic sound system controller 16, such as an audio mixer. The sound system controller 16 contains the amplifiers, volume controls, input selection controls and other such controls required to operate the public address system 12.

The sound system controller 16 amplifies and conditions an incoming audio signal. However, the incoming audio signal can come from many audio signal sources 17. The audio signal sources 17 include, but are not limited to microphones, radio receivers, cable provider receivers, computers, and digital music players, such as MP3 players and DVD players. All of these devices are capable of creating audio signals 18 that can be broadcast over the public address system 12.

The audio tracking system 10 utilizes one or more audio monitoring units 20. Each audio monitoring unit 20 is installed on either the front end of the back end of the sound system controller 16. The preferred installation is at the front end of the sound system controller 16. That is, the audio monitoring unit 20 is preferably installed between the audio signal source 17 and the sound system controller 16.

The audio monitoring unit 20 has an input array of connector ports 22. The input array of connector ports 22 includes many of the most common audio input connector ports, such as XLR ports, RCA ports, phone plug ports, S-video ports, VGA ports and/or coaxial cable ports. Likewise, the audio monitoring unit 20 also contains an output array of connector ports 24. The output array of connector ports 24 are of the same type and number as the input array of connector ports 22. The input array of connector ports 22 are electrically interconnected with the output array of connector ports 24. As such, audio signals 18 received by the input array of connector ports 22 are automatically directed to the output array of connector ports 24. However, within the audio monitoring unit 20, the audio signals 18 traveling from the input array of connector ports 22 to the output array of connector ports 24 is tapped.

The tapped audio signal is conditioned by circuitry 26 in the audio monitoring unit 20 and is converted into a data format that can be recognized by network interface circuitry 28. The resulting systems data 30 signal is transmitted over a communications network 32. The communications network 32 can be the Internet, a telephone communication network, a cable communication network, a fiber optic communication network, or a wireless network, such as a cellular communication network. The audio monitoring unit 20 can send and receive systems data through the communications network 22 either through a wired cable connection or through wireless access.

One audio monitoring unit 20 is needed for each public address system 12 used within the commercial establishment 14. The installation of such audio monitoring units 20 may be voluntary. Alternatively, the installation of audio monitoring units 20 may be a requirement of leased audio equipment or by stipulation in a contract with the Performing Rights Organizations. However, it is ultimately preferred that the installation of the audio monitoring units be mandated by local ordinance or state regulations.

The audio monitoring unit 20 is connected to front end of the sound system controller 16. The audio signal source 17 that is to be broadcast by the sound system controller 16 is connected directly to the audio monitoring unit 20. In this manner, all the audio signals 18 that are transmitted over the public address system 12 must pass through the audio monitoring unit 20.

The audio monitoring unit 20 can be battery powered, but is preferably plugged into the power of the commercial establishment 14. The audio monitoring unit 20 detects when any music or other copyrighted material is broadcast within the commercial establishment 14. The initial source of the audio material is irrelevant so long as the audio signal 18 produced by the audio signal source 17 is tapped by the audio monitoring unit 20.

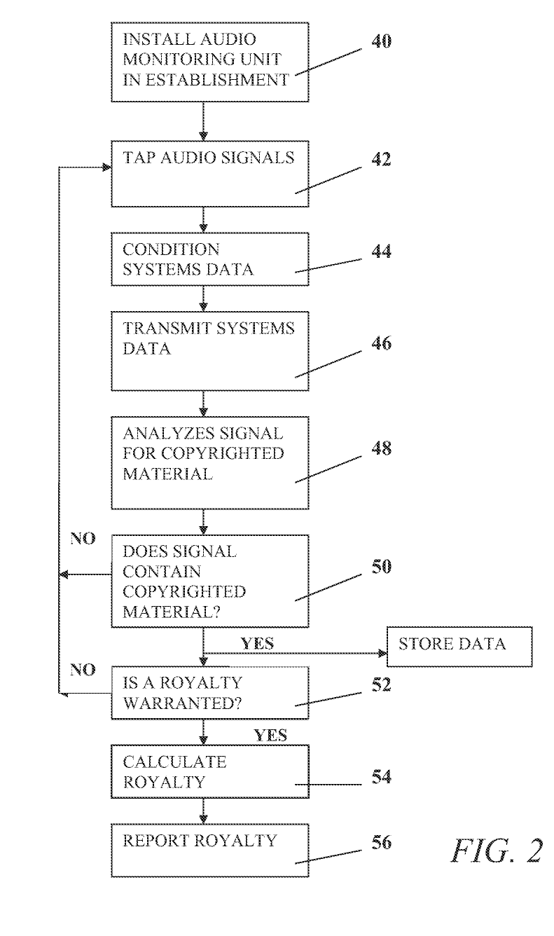

Referring to FIG. 2 in conjunction with FIG. 1, it will be understood that the audio monitoring unit 12 is installed in a commercial establishment 14. See Block 40. Once installed, the audio monitoring unit 20 taps the audio signals 18 that pass through the audio monitoring unit 20 as those audio signals 18 are directed into the public announcement system 12 for broadcast. See Block 42. Those audio signals 18 may or may not include copyrighted material.

The audio signal 18 is converted into corresponding data in a format acceptable to the audio tracking system 10. The systems data is filtered or otherwise conditioned to meet the requirements of the server software 36. The systems data is transmitted to server software 36 using the communications network 32. See Block 46. The server software 36 analyzes the systems data to determine if the systems data contains copyrighted material. Several commercial copyright databases 28, such as 7Digital®, Shazam®, Soundhound®, currently exist that contain extensive libraries of all copyrighted audio material in a digital format. Such systems are used by on-line posting websites, such as YouTube®, to identify when copyrighted material is posted by users. Using the same comparison algorithms and the same or similar databases, the server software 36 analyzes the systems data incoming from the establishment 14. See Block 48.

If the server software 36 detects that any segment of the incoming systems data matches anything in the reference copyright databases 38, then that segment of the systems data can be identified. See Block 50. Once identified, a determination can be made as to whether or not the identified segment warrants the payment of a royalty. See Block 52. This determination possibly depends upon the duration of the identified segment within the systems data and the limitations of the applicable copyright, under the governing state and federal regulations.

If it is determined that any copyrighted material has been performed or broadcast within an establishment 14 and that a royalty is due, then the appropriate royalty fee is calculated. See Block 54. A report is generated that informs the Performing Rights Organizations of what copyrighted material was broadcast, when that broadcast occurred, where it was broadcast along with songwriter information of the copyrighted work in question. See Block 56. Collected royalties are used to pay the copyright owners.

By using the present invention audio tracking system 10, data can also be collected in a secondary usage database 39 as to what kinds of copyrighted material are being broadcast in different types of establishments 14 at different times. This gives the systems administrator 37 of the present invention system the ability to generate statistics and analytics for the copyrighted material, such as ratings, demographic use, trends, and the like. The systems administrator 37 can therefore generate analytics and reports for a variety or targeted criteria. The gathered statistical information is valuable to the copyright owners and can be made available to the copyright owners by the systems administrator 37.

It will be understood that the embodiment of the present invention that is illustrated and described is merely exemplary and that a person skilled in the art can make many variations to that embodiment. For instance, the audio monitoring unit need not be an independent unit, but may be incorporated inside another structure, such as a jukebox that already has an internet connection. All such embodiments are intended to be included within the scope of the present invention as defined by the claims.

What is claimed is:

1. In an establishment having an audio signal source and a sound system controller that receives audio signals from said audio signal source and broadcasts said audio signals through speakers in said establishment, a method of determining if said audio signals contain copyrighted material, said method comprising the steps of:
connecting an audio monitoring unit to said sound system controller, wherein said audio monitoring unit receives said audio signals being broadcast through said sound system controller and converts said audio signals into corresponding systems data, and wherein said audio monitoring unit communicates with a communications network;
transmitting said systems data over said communications network to a network server, wherein said network server compares said systems data to a database of copyrighted audio data to find any matches;
analyzing said matches to determine if any of said matches warrants a royalty payment.

2. The method according to claim 1, further including the step of billing said royalty payment to said establishment.

3. The method according to claim 1, wherein said audio monitoring unit has an input port array and an output port array.

4. The method according to claim 3, wherein said step of connecting said audio monitoring unit to said sound system controller includes connecting said sound system controller to said output port array of said audio monitoring unit.

5. The method according to claim 4, further including the step of attaching said audio signal source to said input port array of said audio monitoring unit.

6. In an establishment having an audio signal source, a sound system controller, and speakers, wherein said sound system controller receives audio signals from said audio signal source and broadcasts said audio signals through said speakers, a method of determining if said audio signals contain copyrighted material, said method comprising the steps of:
providing an audio monitoring unit having signal input ports and signal output ports, wherein said audio monitoring unit taps audio signals traveling between said signal input ports and said signal output ports;
connecting said audio monitoring unit to said sound system controller in said establishment, wherein said audio monitoring unit receives said audio signals being broadcast through said sound system controller and converts said audio signals into corresponding systems data;
transmitting said systems data to a computer wherein said computer analyzes said systems data for segment matches with copyrighted material;
analyzing said segment matches to determine if any of said segment matches warrant a royalty payment.

7. The method according to claim 6, further including the step of billing said royalty payment to said establishment.

8. The method according to claim 6, wherein said step of connecting said audio monitoring unit to said sound system controller includes connecting said sound system controller to said output port array of said audio monitoring unit.

9. The method according to claim 6, further including the step of attaching said audio signal source to said input port array of said audio monitoring unit.

10. The method according to claim 6, wherein said step of transmitting said audio data to a computer includes providing a computer remote from said establishment that receives said systems data over said communications network.

11. In an establishment having a sound system controller and speakers, wherein said sound system controller receives audio signals from an audio signal source and broadcasts said audio signals through said speakers, a method of reporting broadcasts of copyrighted material to a royalty collection organization, said method comprising the steps of:
placing an audio monitoring unit in said establishment, wherein said audio monitoring units contain an audio input plug and an audio output plug, wherein said audio signal source is directly connected to said audio input plug and said sound system controller is directly connected to said audio output plug, wherein said audio monitoring unit detects said passing from said audio source to said sound system controller and creates systems data corresponding to said audio signals;
transmitting said systems data to a computer wherein said computer analyzes said systems data for segment matches with copyrighted material;
reporting said segment matches to said royalty collection organization.

12. The method according to claim 11, further including the step of having said computer determine if said segment matches warrant a royalty payment depending upon duration of said segment matches.

13. The method according to claim 11, wherein said step of transmitting said audio data to a computer includes providing a computer remote from said establishment that receives said systems data over a communications network.
